(19) United States
(12) Patent Application Publication
(10) Pub. No.: US 2019/0032962 A1
(43) Pub. Date: Jan. 31, 2019

(54) SOLAR THERMAL PANTILE HAVING LONGITUDINALLY ADJUSTABLE CONNECTING ELEMENT

(71) Applicant: RHEINENERGIE AG, Köln (DE)

(72) Inventor: Peter HAKENBERG, Solingen (DE)

(21) Appl. No.: 16/073,811

(22) PCT Filed: Jan. 30, 2017
(86) PCT No.: PCT/EP2017/051893

§ 371 Date: Jul. 30, 2018

(30) Foreign Application Priority Data
Jan. 29, 2016 (DE) 10 2016 101 644.6

(51) Int. Cl. F24S 20/69; F24S 10/70; F24S 80/30

(52) U.S. Cl. CPC F24S 20/69; F24S 2025/6004; F24S 80/30; F24S 10/70

(57) ABSTRACT

The invention relates to a solar thermal pantile (20) for the production of thermal energy from solar radiation, the shape of which essentially corresponds to the shape of a conventional roof tile, comprising an absorber (26) passed-through by a medium, having an inlet line (34) and an outlet line (36), which is arranged on a base tile (22), which is for mounting the solar thermal pantile (20) on a roof, wherein
the inlet line (34), at its free end, comprises a first connecting element (38),
the outlet line (36) is formed, and, at its free end, comprises a second connecting element (40),
at least one of the two lines (34, 36) is formed as being variable in length,
the two connecting elements (38, 40) are connectable to each other,
in an initial state, both connecting elements (38, 40) are arranged within outer dimensions of the solar thermal pantile (20),
in an assembly state at least one of the two connecting elements (38, 40) may be pulled out beyond the outer dimensions of the solar thermal pantile (20), so that it is connectable to a first connecting element (38, 40) of an adjacent solar thermal pantile (20).

The present invention relates to a solar thermal pantile to produce thermal energy from solar energy, wherein the solar thermal pantile essentially has the shape of conventional pantiles.

Solar-thermics, especially the provision of hot water, is the most widespread technique for utilization of solar radiation, wherein solar collectors are used to heat fluids. The solar radiation meanwhile enters an absorber surface of the collector to heat it. The generated heat will be transferred to a flow-through medium, generally a fluid or even air. The medium heated by the solar radiation is usually passed to a hot water storage tank by a circulating pump, wherein the generated heat is transferred from the heated medium (e.g. a carrier fluid) to the industrial water or drinking water in the hot water storage tank via a heat exchanger. During this, the medium cools down and will subsequently be recycled back to the collector.

If a fluid is used as a medium, a mixed antifreeze liquid and water is especially suitable. Alternatively, heating-circuit water itself may be pumped into the collector and may be heated therein. Even in this case drinking water max be heated via the heat exchanger.

Utilization of roof surfaces for affixing solar collectors is widespread. Commercially available solar collectors, flat collectors or even vacuum tube collectors are mostly applied to already completed roofs in addition. Fastening elements are often required to be mounted through the roofing sheet onto the roof supporting structure, wherein fastening is required to be storm-proof and is preferably also required to be corrosion-protected. When perforating the conventional roofing sheet, sealing and subsequent tightness problems inevitably will arise. Moreover, increase of the roof load occurs, often resulting in a necessary reinforcement in the roof trusses. Moreover, such solar collectors negatively interfere with the optical appearance of the roof.

Alternatively, solar thermal pantiles are known, which are used instead of the generally used pantiles, roof tiles or roofing stone articles. Solar thermal pantiles also comprise an absorber for receiving the solar energy and are passed through by a medium, preferably a fluid, which becomes heated accordingly. In this way, the above-mentioned disadvantages of the assembled solar collectors will largely be avoided, but installation of such solar pantiles is laborious, and is relatively difficult, compared to conventional roof covering with commercially available roof tiles. An essential problem especially is the great installation effort when connecting the individual solar thermal pantiles. The through-passing medium is required to be passed from one solar thermal pantile to the next one, requiring suitably tight connection. Thus, expenditure in time and assembly work is significantly higher.

For example, such solar thermal pantile and the assembly thereof is described in DE 10 2011 055 904 A1 and in DE 20 2013 002 407U1. Assembly of the roof tiles as described therein is complex and difficult, especially as additional components and modifications to the supporting structure are required.

DE 30 36 897 A1 and US 2008/0283044 A1 also describe roof covering elements to produce solar energy. Herein, it is also true that adaption to given preconditions on the roof, especially to the length and width dimensions of the roof, is very difficult. According to the first-mentioned document, use of roof covering elements, for example, requires use of sealing materials or bands to compensate fitting differences. The solar collectors described in the second-mentioned document optically differ significantly from the usual pantiles.

The object of the present invention is to provide a solar thermal pantile the production, assembly and maintenance of which is as simple and inexpensive as possible. In this context, it is essential for the mounting procedure to differ as little as possible from a roof covering procedure with usual roof tiles. The overall system for energy conversion, which makes use of the solar thermal pantiles according to the invention is then expected to operate in a permanent and reliable manner.

The object will be solved by a solar thermal pantile having the features of the claim 1.

Thus, a solar thermal pantile according to the invention comprises an absorber arranged on the top side and being passed through by a medium, having an inlet line and an outlet line, the absorber being arranged on a base tile. The base tile is for fixing the solar thermal pantile on a roof.

The shape of the solar thermal pantile according to the invention essentially corresponds to the shape of a conventional roof tile, so that the appearance of a roof or a house, respectively, will hardly be changed by the use of the solar thermal pantile. In this context, the meaning of roof tile is to be understood as being synonymous to roof covering elements, such as roof tiles, roofing stones or roofing shingles, and is not meant to limit the invention to roof tiles.

In the following, it is to be considered that a fluid serves as a medium, wherein a gaseous medium, for example air, may also be conceivable. The inlet line, at its free end, has a first connecting element, and the outlet line, at its free end, has a second connecting element, which are interconnectable in fluid-medium communication. What is essential is that both lines are embodied as being variable in length. In this way, in a first initial state, both connecting elements may be arranged within outer dimensions of the solar thermal pantile, in the assembly state, the connecting element may be expanded due to its length-changeable line so that it projects beyond the outer dimensions of the solar thermal pantile. In this context, the meaning of outer dimensions or overall dimensions relates to the overall dimensions of the solar thermal pantile in planar or horizontal extension, respectively, which in a common rectangular solar thermal pantile are determined by the two longitudinal sides and the two transverse sides. In this context, the meanings horizontal and vertical relate to a solar thermal pantile abutting on a horizontal plane, so that the main extension thereof extends in the horizontal plane.

An advantage of the at least one length-changeable line is that, during roofing procedure, differing tiles may be compensated. The variable overlapping of the roof tiles results from different roof batten clearances, which in turn arise due to the integer number of roof tiles, when varying the roof lengths (from the gutter board to the crest) will be realized.

Basically, according to the invention, the inlet line or the outlet line or even both lines may be formed as being variable in length, in an especially advantageous embodiment, according to the invention, the outlet line is formed as being variable in length. In the following, the invention will therefore be exemplified for that embodiment, but which is only one of the various possibilities.

The second connecting element connected to the outlet line is preferably guided in a longitudinal groove extending in a pull-out direction in the base tile. On the other hand, the inlet line and the first connecting element are arranged locally fixed within the outer dimensions of the solar thermal pantile.

This means that the solar thermal pantile according to the invention, in its initial state, has the same dimensions as a commercially available roof tile without solar thermics utilization. In the assembly state, however, the second connecting element may be pulled out beyond the outer dimensions of the solar thermal pantile and may be connected to a first connecting element of an adjacent solar thermal pantile. Both of the connected solar thermal pantiles may subsequently be moved towards each other, wherein the outlet line contracts again, until the two solar thermal pantiles, in some areas, are arranged one over the other such that the two connecting elements are arranged below the upper solar thermal pantile, i.e. they are arranged as being no more visible.

The inlet line variable in length significantly facilitates assembly onto the roof, as the distance deviations between adjacent solar thermal pantiles during roofing may quickly and simply be compensated.

The meaning of inlet line variable in length is to be understood such that said inlet line changes in its length in relation to the pull-out direction of the second connecting element. In an especially preferred embodiment, the outlet line may hence be formed as a so called trumpet tube, wherein two tube portions of different diameter that are sealed against each other may slide into each other. Alternatively, an outlet line may also be used, the absolute length of which remains constant, but which allows increase in length in pull-out direction due to the change in geometric set-up. This, for example, applies to a helically wound elastic outlet line, which, according to the invention, may also be used. Finally, operation of the invention is essential, in that the outlet line allows for the second connecting elements to be pulled out.

In an especially advantageous embodiment, the two connecting elements are formed as a snap-in connection or as an engaging connection. For example, the first connecting element may comprise an accommodation opening, into which the second connecting element is insertable and is releasably maintained in a form-fitting manner. Form-fitting, in this context, may be effected by undercutting in the accommodation opening, to which undercut a retaining edge of the second connecting element abuts.

To effect safe but still releasable connection, elastic engaging means may be provided, which engage into the respective retaining region. In a particularly easy embodiment, the second connecting element may comprise openings or recesses, into which elastic and/or spring-loaded pins of the first connecting element engage. During connection procedure, the pins are initially displaced by the second connecting element until they may return back into the respective recesses or openings.

In the engaged state, the two connecting elements are fixedly connected, wherein the connection especially is effected by at least one, preferably two spring-loaded pins. In this context, the engaging openings and the free end of the pin are dimensioned such that the pin is only partially and not completely inserted into the opening. For this, the pin, at its free end, may be formed conically. It will thereby be achieved that the connection in vertical direction, i.e. transversally to the insertion direction of the pin, is locked, on the other hand, the spring force acting in longitudinal direction of the pin compresses the two connecting elements towards each other, thereby assuring a tight connection. It is to be understood that other engaging connections may also be utilized, which ensure sufficiently reliable connection of the two connecting elements. It thereby is essential that the connection for the passing-through fluid is tight.

The solar thermal pantile preferably has a sandwich design, wherein the absorber with the respective connecting elements is arranged between the base tile that comprises the elements for mounting onto a roof supporting structure and a transparent covering element. The absorber may consist of an upper non-medium-containing absorber element and a lower medium-containing absorber element. The upper absorber element is designed such that it heats-up to the maximum, especially by way of dark or black coloring, respectively. It is preferred, that the two absorber elements are fabricated of metal and are soldered or welded to each other. In order to keep the manufacture especially easy and cost-effective, the roll-welding process has been proven as a preferred connecting process. Both the upper absorber element itself and the base tile may be produced by a deep drawing process.

A circumferential frame element arranged between the base tile and the absorber or the covering element, respectively, is, on the one hand, for fixing the individual elements to each other, and on the other hand, the tightness of the solar thermal pantile will be increased.

Advantageously, the connection may be released (with the help of an appropriately formed tool) by compressing the pins opposite to the spring force, and the second connecting element will be pulled out of the first connecting element. For this, for example an appropriate tool may be used, which disengages the pin and the engaging opening.

In order to additionally facilitate assembly, the second connecting element is preferably guided at the absorber or the base tile. The guide may for example be effected by a longitudinal groove in the base tile, into which the retention region of the second connecting element protrudes and is retained. It is thereby assured that the second connecting element may exclusively displace along the longitudinal groove and especially may not get distorted.

In an especially advantageous embodiment, the accommodation opening is formed within the first connecting element in a T-shaped manner and is formed as being open towards the top. Accordingly, the second connecting element is also formed in a T-shaped manner and is insertable into the accommodation opening from the top. By way of the T-shape, locking in the essentially horizontal pulling direction is automatically realized. For the connection in the vertical direction may not release, spring-loaded pins, which are arranged in the first connecting element, engage into openings of the second connecting element, which are preferably arranged in the two short regions of the T-shape that are formed transversally to the most longitudinal extension of the outlet line.

Thus, the solar thermal pantiles according to the invention may be installed fast and easy onto a roof supporting structure. They may be transferred, with the second connecting element being retreated, like commercially available roof tiles onto the roof and may be processed thereon. For this, it is only required for the second connecting element to be pulled out of the solar thermal pantile and to couple it, via the engaging connection, to an adjacent first connecting element.

An overall system for utilization of thermal energy comprises the above-described solar thermal pantiles, wherein, in addition, a manifold, preferably below the so called ridge-tile row, and a supply line, which preferably replaces the so called gutter board, are provided. For this, the uppermost row of solar thermal pantiles adjacent to the ridge-tile row will be connected via a collecting supply line, which especially may be formed elastically, to the collecting line. The collecting supply line may also be formed as being variable in length, but very often, a relatively supple and flexible tubing will also be sufficient. It replaces the outlet line, i.e. it is not connected to the absorber, but has a free end, which may be inserted into the collecting line.

The solar thermal pantiles adjacent to the gutter board have supply feeding lines instead of inlet lines. The supply feeding line may also be formed as being variable in length, but here also a flexible tubing will very often be sufficient. The supply feeding line is connected to the first connecting element, but has no connection towards the absorber, but, with its free end, is rather connectable to the feeding line.

The collecting line and the feeding line are each connected to the heating system in the house, preferably the heat exchanger. Appropriate connecting lines, a cold water line towards the feeding line and a hot water line towards the collecting line may be installed inside or outside of the house. Installation within a downspout that is arranged within a house has been proven to be especially advantageous. Said downspout is for discharging rainwater, but on the other hand, the connecting lines may be accommodated in the interior thereof. In an especially preferred embodiment, said connecting lines may be separated by separating wall from a rainwater-conducting region of the downspout. Thus, for this purpose, the downspout is divided into two compartments.

The solar roof tile of the invention is especially suitable for use with a wind suction protection which is also new and advantageous. In some geographic regions, wind suction protections have already become mandatory. Prevention of unroofing the roof due to storm (wind suction) is therewith intended. This will typically be realized by attaching a wire or a clamp to the roof tile, which anchors the roof tile in the roof batten. The anchoring procedure is comparatively time-consuming, and depending on the on-site situation, sometimes requiring more time than the roofing procedure with the roof tile. Moreover, it is extremely difficult to replace such a roof tile (e.g. if it is damaged) in the roof network structure (completely tiled roof).

The wind suction protection of the invention diminishes those problems. A snap-in lug is activated when overlaying the roof tile onto the roof tile, it will be urged behind the roof tile by spring force and thus clasping behind. For disengaging this connection mechanism, if repair is required, a return mechanism having a draw bar including draw bar eye is advantageously provided at the bottom side of the roof tile in the front region. When slightly lifting the roof tile in the front, it is possible for a hook to engage into the draw bar eye and drawing the snap-in lug back to its engaging position. This engaging position is the delivery default state and will be changed during roofing procedure, i.e. when the roof tile will be installed on the roof batten in proper position.

Replacing a conventional roof tile has always been relatively difficult (even without additional wind suction protection). This resides in that the roof tile to be replaced is required to be removed from the roof batten, even though two adjacent roof tiles (overlaying on top and usually on the left hand thereof) are loaded thereon. However, if another two connections are required to be released, this is almost impossible, unless additional auxiliary tool will be used. The wind suction protection with snap-in lug solves the problem by providing an additional mechanism for lifting the roof tile. For this, a draw bar including draw bar eye is pulled under the roof tile at the front end, which in turn actuates a draw key between the roof tile and the roof batten to lift the roof tile.

Another improvement or alternative of the invention, respectively, resides in the actuation of another draw bar including draw bar eye at the front end of the roof tile to release the connection between the roof tiles by actuating an ejector (to eject a pater out of the mater). In this way, a lifting tool becomes unnecessary.

Said three draw bar eyes are all located below the roof tile at the lower end. The draw bar eyes are vertically oriented and would “spring-off” from the bottom side of the roof tile as soon the latter will be lifted in the front. An eye is then advantageously slightly offset from the center of the roof tile (center of the front side) and releases the connection. This position is advantageous as the connection is arranged as being exactly located in the center of the roof tile. Some centimeters offset thereof, for example about 3 cm to the left, according to the invention, the draw bar eye for the snap-in lug of the wind suction protection is positioned. This position is advantageous as the typical wind suction protection is always provided at the left roof tile side. On the other side, some centimeters to the right of the center, preferably also 3 cm to the right of the center, the draw bar eye for the draw key is preferably arranged, which is for lifting the roof tile.

According to the invention, combination of the draw bar eyes for the snap-in lug and the roof tile lifter is conceivable. The sequence would be such that in the first half of the draw path, the snap-in trap will be retracted, and in the second half of the drawing distance, the draw key for lifting the tile will be actuated. It is preferred that a spring element is provided, via which the bias applied to the snap-in lug will be maintained, for said snap-in lug does not snap back when lifting.

The invention will be explained in detail by way of the following figures, said figures showing a preferred working example of the invention, which, however, is not intended to limit the invention to the features shown, wherein

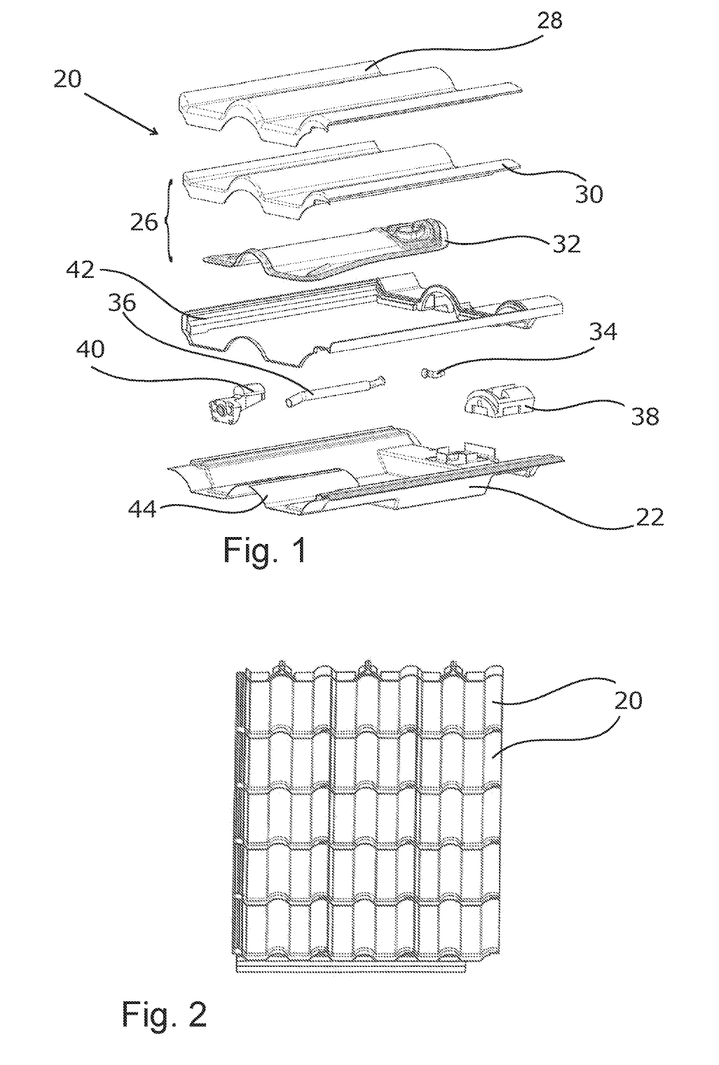

FIG. 1: shows an explosion representation of the solar thermal pantile according to the invention;

FIG. 2: shows a portion of a roof, which is covered with the solar thermal pantiles according to the invention;

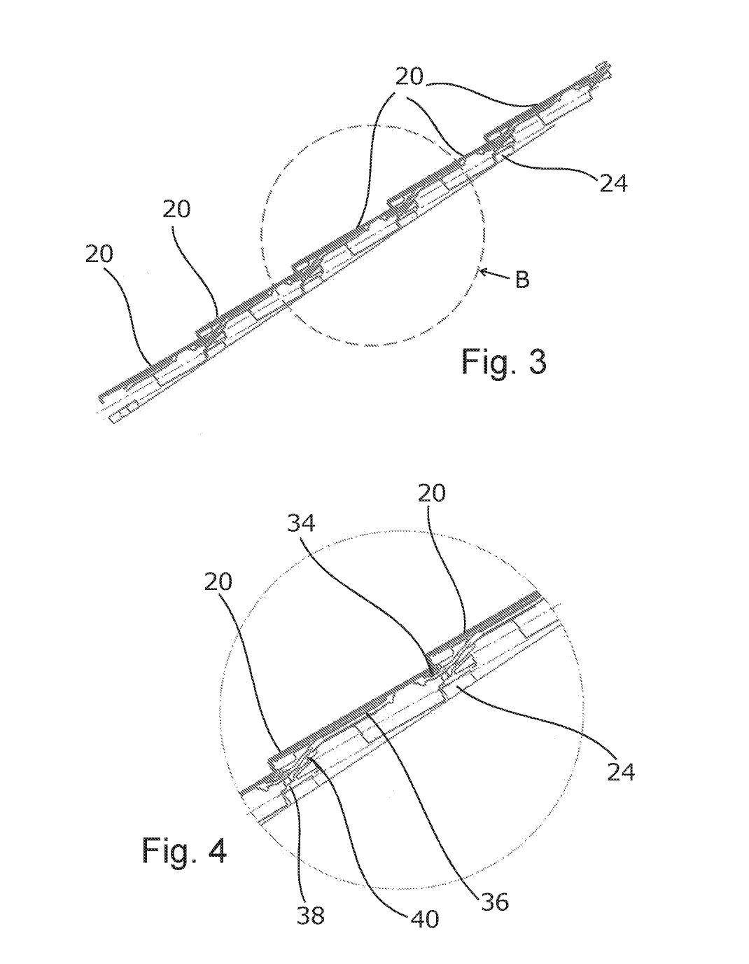

FIG. 3: shows a cross section of the row of installed solar thermal pantiles;

FIG. 4: shows an enlarged sectional view of FIG. 3;

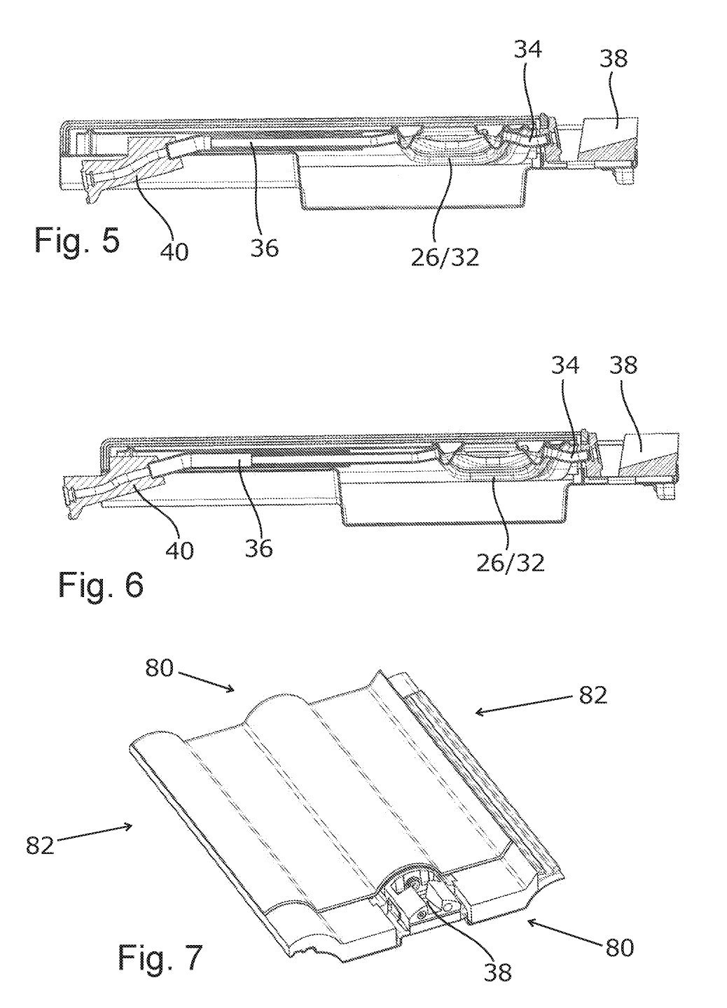

FIG. 5: shows a longitudinal section of the water-containing unit of the solar thermal pantile;

FIG. 6: shows a longitudinal section of the solar thermal pantile according to the invention, with the connecting element being extended;

FIG. 7: shows a top view of the solar thermal pantile according to the invention;

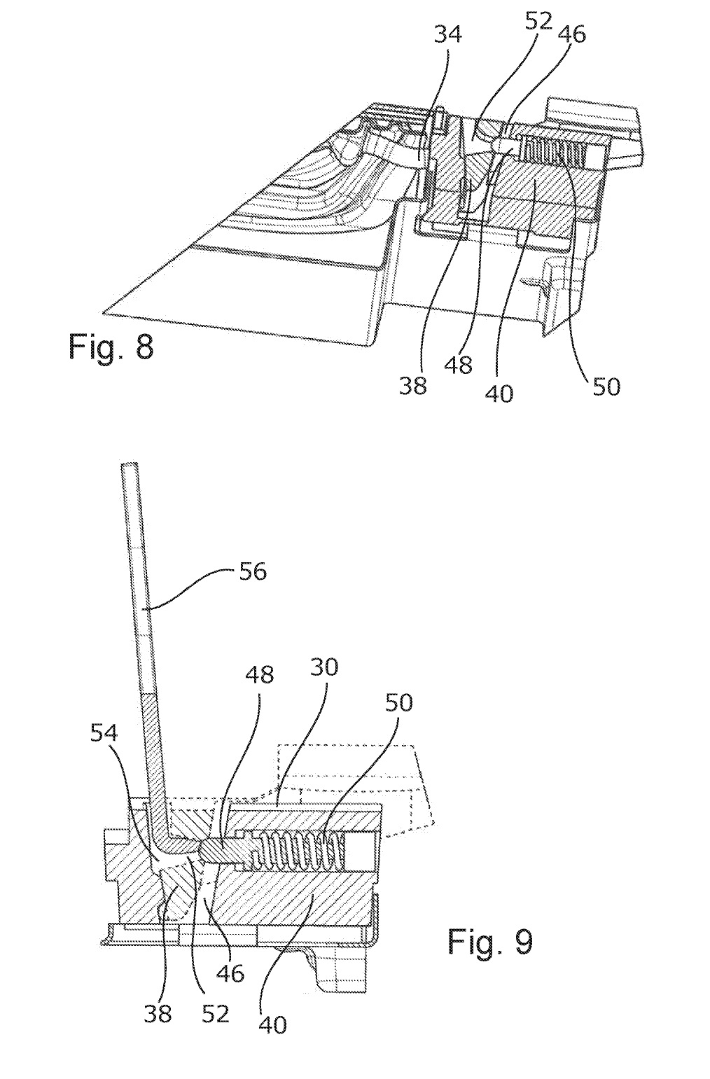

FIG. 8: shows two connecting elements of two solar thermal pantiles in the assembled state;

FIG. 9: shows a releasing operation of the connection of FIG. 8 with the help of a tool;

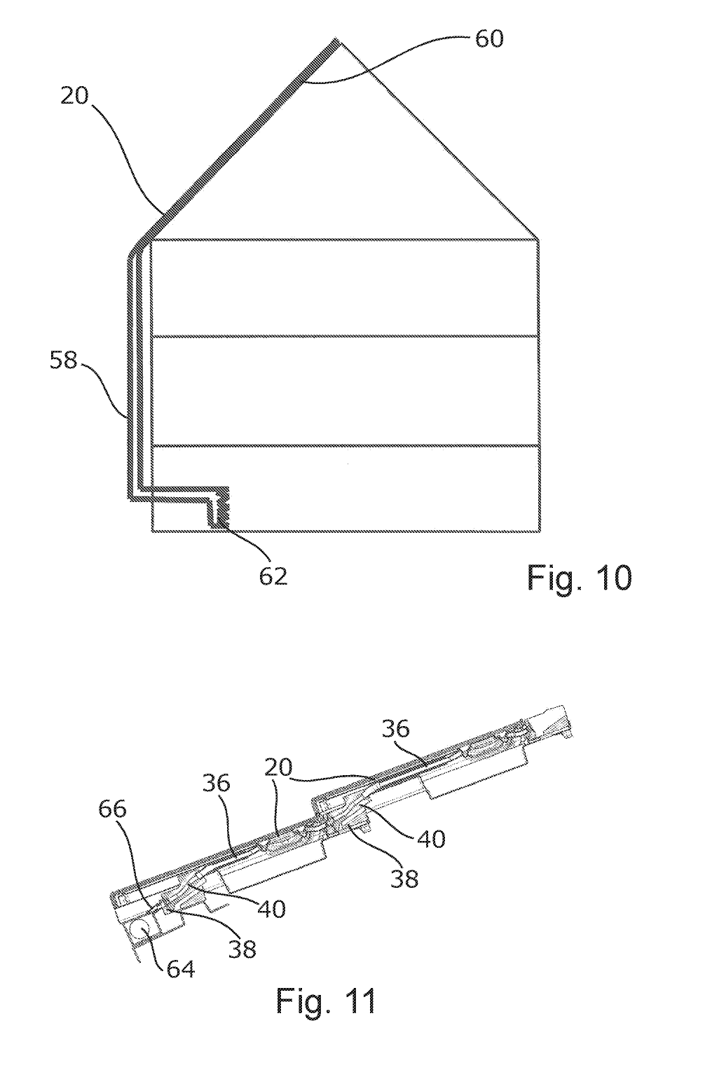

FIG. 10: shows a strongly simplified representation of a system for obtaining thermal energy according to the invention;

FIG. 11: shows coupling of solar thermal pantiles to a feeding line;

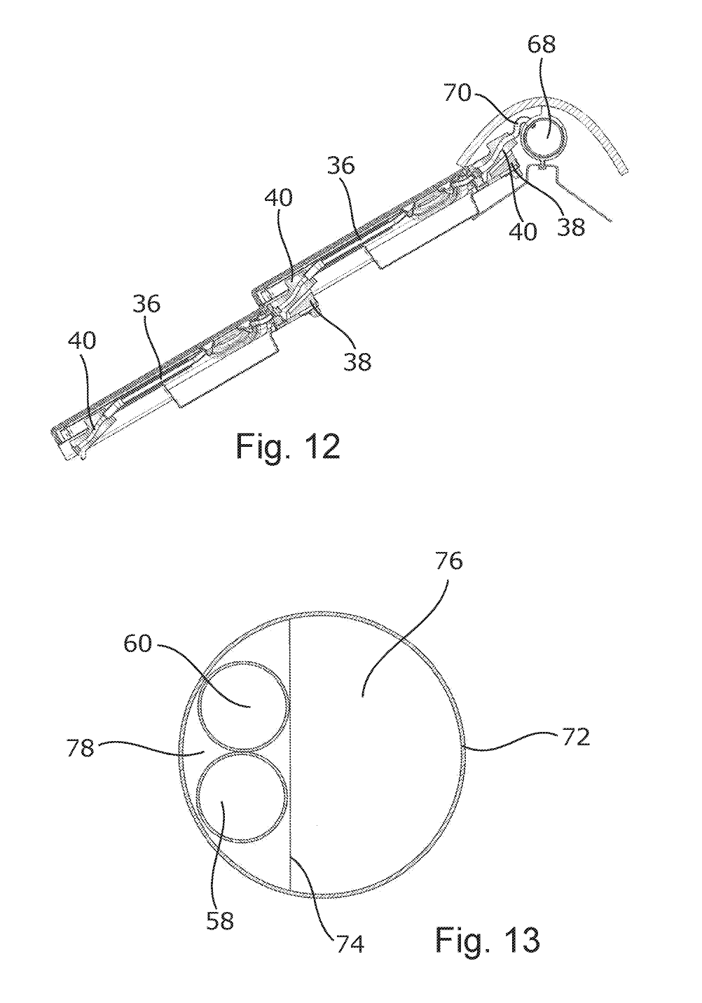

FIG. 12: shows coupling of the solar thermal pantiles to a manifold;

FIG. 13: shows a cross section of a downspout including connecting lines.

FIG. 1 shows an explosion representation of a preferred embodiment of a solar thermal pantile 20 according to the invention. Basically, the solar thermal pantile 20 is formed in a sandwich-type design. Starting from of a base tile 22, which forms a bottom side of a solar thermal pantile 20 and is laid on top of a roof supporting structure 24 (also cf. FIG. 3), followed by an absorber 26 and preferably a transparent or translucent cover 28. It is to be seen that the absorber 26 is formed of an upper absorber element 30 and a lower absorber element 32.

The cover 28 approximately has the same shape as the upper absorber element 30, thus entirely covering said absorber element. The lower absorber element 32 will be passed-through by a fluid not shown. It is therefore coupled to an inlet line 34 and an outlet line 36. The inlet line 34 is followed by a first connecting element 38 and the outlet line is followed by a second connecting element 40. The two connecting elements 38, 40 may each be coupled to a corresponding connecting element 38, 40 of an adjacent solar thermal pantile 20.

A frame 42 is furthermore shown, approximately having the dimensions of the base tile 22 and serving for the accommodation of the absorber 26. Moreover, in the working example shown, the cover 28 is supported on the frame 42 and is connected thereto.

In FIG. 1, it is not to be seen that the second connecting element 40 is guided in a longitudinal groove 44 of the base tile 22. This significantly facilitates installation of the solar thermal pantile 20 by way of specifically pulling out the second connecting element 40. The longitudinal groove 44 furthermore avoids distortion of the second connecting element 40.

Finally, it is essential for the outlet line 36, which is arranged between the lower absorber element 32 and the second connecting element 40 to be variable in length. In the working example shown, it is formed as a trumpet pipe, which is formed of two pipe portions which are slideable into each other and having different diameters.

From the FIGS. 2 to 4, the installation according to the invention of solar thermal pantiles 20 on a roof or a roof supporting structure 24, respectively, becomes clear. FIG. 2 shows a top view of a region of a roof, FIG. 3 shows a longitudinal section across a row of solar thermal pantiles 20, and FIG. 4 shows an enlarged view of the region B from FIG. 3.

It is to be seen that the solar thermal pantiles 20 which are connected to each other, overlap in some areas, similar to conventional roofing with common roof tiles. They then abut with their bottom side, i.e. the bottom side of the base tile 22, on the roof supporting structure 24. Especially in FIG. 4 it is shown that respective adjacent solar thermal pantiles 20 arranged one over the other, are connected to each other via the connecting elements 38, 40. Fluid passing through will then be transferred from of a solar thermal pantile 20 through the inlet line 34, the two connecting elements 38, 40, the absorber 26 and the outlet line 36 to the next solar thermal pantile 20.

FIG. 5 explains the design of the solar thermal pantile 20 according to the invention. It is to be seen that the first connecting element 38 is followed by the inlet line 34 and leading to the lower absorber element 32. After the fluid flows through the lower absorber element 32 and has appropriately been heated it is passed to the second connecting element 40 through the outlet line 36.

For installation of the solar thermal pantiles 20 it is furthermore of advantage, that the absorber 26, especially the upper absorber element 30 as well as the cover 28, do not entirely cover the first connecting element 38 so that it easily remains accessible during tiling the roof. The first connecting element 38 will finally be first covered by the installed adjacent solar thermal pantile 20, thereby being no longer visible in the installed state.

FIG. 6 shows a longitudinal section of a solar thermal pantile 20 having extended second connecting element 40. The outlet line 36, which, in the working example shown, is formed as a trumpet pipe, is variable in length, so that the second connecting element 40 may be pulled out beyond the overall dimensions of the solar thermal pantile 20. It then protrudes opposite of the respective edge or side of the solar thermal pantile 20 and may smoothly be connected to an adjacent first connecting element 38.

FIG. 7 explains, by way of a top view representation of the solar thermal pantile 20, that in the initial state there are no elements protruding over overall dimensions of the solar thermal pantile 20. The overall dimensions are specified by the two transverse sides 80 and the two longitudinal sides 82. It may as well be seen that an accommodation opening 46 of the first connecting element 38, in the initial state, is not covered by the absorber 26 or the cover 28, but is open towards the top, i.e. towards the direction facing away from the base tile 22. The accommodation opening 46 essentially is formed as being T-shaped.

The FIGS. 8 and 9 exemplify the advantageous connection o two solar thermal pantiles 20 via the two connecting elements 38, 40. The two connecting elements 38, 40 are shown in longitudinal section view, wherein the outlet line 36 is not being drawn. What may be seen is the accommodation opening 46 (or accommodating recess), into which the second connecting element 40 is insertable. The T-shape causes the connection to be secured in essentially horizontal direction, i.e. in the pull-out direction of the second connecting element 40, and the two connecting elements 38, 40 may not be disengaged from each other.

In addition, spring-loaded pins 48 are to be seen as snap-in elements. In the working example shown, two pins 48 are provided, each one of which being oriented parallel adjacent to the outlet line 36.

A spring element 50 urges the respective pin 48 towards an accommodation 52, which is arranged in the second connecting element 40. A snap-in or click connection will thereby result, which also secures essentially in the vertical direction, i.e. transversally to the pull-out direction of the second connecting element 40. The pins 48 each have a conically shaped free end, the diameter of which is dimensioned such that the pins 48 will not be entirely inserted into the respective accommodation 52. In this way, it will be achieved that the spring force of the spring element 50 acts towards an appropriate edge of the respective accommodation 52, thus urging the second connecting element 40 against an opposite opening of the inlet line 34. The openings of the outlet line 36 and the inlet line 34 therein abut each other. The pressure of the spring element 50 causes a tight connection between the two connecting elements 38, 40 to be assured.

FIG. 9 furthermore shows that, in the assembled state of the two connecting elements 38, 40, an access opening 54 for a tool 56 results. Into this access opening 54 an angular-shaped tool 56 is insertable, by which tool the two pins 48 may be pushed back against the spring force of the spring element 50, thus allowing release of the two connecting elements 38, 40 from each other.

From FIG. 10 it will arise how a system is to be designed, which makes use of the solar thermal pantile according to the invention 20. Relatively cold fluid is supplied to the solar thermal pantiles 20 via a cold water line 58. Said fluid will be heated when flowing through the solar thermal pantiles 20 connected to each other, and will be recycled via a hot water line 60 back to the heat exchanger 62, or alternatively will be recycled back to direct utilization. The two connecting lines, i.e. the cold water line 58 and the hot water line 60, couple the solar thermal pantiles 20 to the utilization facility, for example a water supply system of house.

FIG. 11 explains the conveyance of the relatively cold fluid via a feeding line 64 to solar thermal pantiles 20. The feeding line 64 preferably is arranged in the region of a gutter board of the roof. A row of solar thermal pantile 20, which are arranged in the edge region of an area of solar thermal pantiles 20 according to the invention, preferably the lower row of a roof, is coupled to feeding line 64 via a supply feeding line 66. The supply feeding line 66 connects the feeding line 64 to each of the first connecting element 38 of a solar thermal pantile 20.

FIG. 12 shows attachment of the solar thermal pantiles 20 of the uppermost row to a collecting line 68. A collecting supply line 70 extends from the second connecting element 38 into the collecting line 68, feeding heated fluid thereto.

FIG. 13 explains an advantageous installation of the connecting lines, i.e. the cold water line 58 and the hot water line 60, in places within a downspout 72. In this case, the downspout 72 preferably is divided into two compartments by a separating wall 74, wherein a first compartment 76 is for discharging rain water, a second compartment 78 is for accommodating the two connecting lines 58, 60. This mode of installation, on the one hand, is cost-effective and quickly feasible, on the other hand the external appearance of the house will not negatively be affected.

The invention is not limited to the working examples shown and represented, but also includes other possible embodiments. Especially, instead of the outlet line 36, the inlet line 34 or even both lines 34, 36 may be formed as being variable in length. It is also conceivable that, instead of the base tile 22, the absorber 26 directly is for mounting to the roof structure 24, i.e. the base tile 22 may thus be omitted.

1. A solar thermal pantile (20) for the production of thermal energy from solar radiation, the shape of which essentially corresponds to the shape of a conventional roof tile, comprising an absorber (26) having an inlet line (34) and an outlet line (36)and being passed by a medium, the absorber being arranged on a base tile (22), which is for mounting the solar thermal pantile (20) on the roof, wherein
the inlet line (34), at its free end, comprises a first connecting element (38),
the outlet line (36), at its free end, comprises a second connecting element (40),
at least one of the two lines (34, 36) is formed as being variable in length,
the two connecting elements (38, 40) are connectable to each other,
in an initial state, both connecting elements (38, 40) are arranged within outer dimensions of the solar thermal pantile (20),
in an assembly state, at least one of the two connecting elements (38, 40) may be pulled out beyond the outer dimensions of the solar thermal pantile (20), so that it is connectable to a corresponding connecting element (38, 40) of an adjacent solar thermal pantile (20).

2. The solar thermal pantile (20) according to claim 1, characterized in that the outlet line (36) is formed as being variable in length.

3. The solar thermal pantile (20) according to claim 2, characterized in that the first connecting element (38) and the inlet line (34) are arranged locally fixed within the solar thermal pantile (20).

4. The solar thermal pantile (20) according to claim 1, characterized in that the two connecting elements (38, 40) are formed such that they form a snap-in connecting.

5. The solar thermal pantile (20) according to claim 1, characterized in that the first connecting element (38) comprises an accommodation opening (46) T-shaped in the horizontal plane, open towards the top for accommodating the second connecting element (40) which is also formed as being T-shaped.

6. The solar thermal pantile (20) according to claim 5, characterized in that the second connecting element (40) comprises at least one accommodation (52), into which a snap-in element arranged in the first connecting element (38) is engageable.

7. The solar thermal pantile (20) according to claim 6, characterized in that the snap-in element is formed as a spring-loaded pin (48), wherein the accommodation (52) and the pin (48) are oriented essentially in the horizontal direction.

8. The solar thermal pantile (20) according to claim 7, characterized in that free end of the pin (48) is formed in a conically tapering manner such that said pin contacts an edge that limits the accommodation (52).

9. The solar thermal pantile (20) according to claim 8, characterized in that the two connecting elements (38, 40), in the assembled state of the two connecting elements (38, 40), form an access opening (54) foe a tool (56), by means of which the pin (48) may be urged backwards, allowing release of the two connecting elements (38, 40) from each other.

10. The solar thermal system for the production of thermal energy from solar radiation, comprising solar thermal pantiles (20) according to claim 1 connected to each other, which are coupled to a utilization facility via a cold water line (58) and a hot water line (60).

11. The solar thermal system according to claim 10, characterized in that
in the edge region of an area of solar thermal pantiles (20) according to the invention, solar thermal pantiles (20) are each coupled via a supply feeding line (66) to a feeding line (64), which is connected to the cold water line (58),
solar thermal pantiles (20), in the opposite edge region of the area, are each coupled to a collecting line (68) via a collecting supply line (70), which is connected to the hot water line (60).

12. The solar thermal system according to claim 10, characterized in that the cold water line (58) and the hot water line (60) in some places are arranged in a downspout (72).
